(19) United States
(12) Patent Application Publication
(10) Pub. No.: US 2023/0005503 A1
(43) Pub. Date: Jan. 5, 2023

(54) HEAT-ASSISTED MAGNETIC RECORDING (HAMR) MEDIA WITH MAGNESIUM TRAPPING LAYER

(71) Applicant: Western Digital Technologies, Inc., San Jose, CA (US)

(72) Inventors: Takashi Iwanami, Fujisawa (JP); Kouji Matsuda, Fujisawa (JP); Junguo Xu, Kasumigaura (JP); Kenji Tasaka, Yokohama (JP); Hoan Cong Ho, San Jose, CA (US); Tomoko Seki, Sunnyvale, CA (US); Paul Christopher Dorsey, Los Altos, CA (US); Masayoshi Shimokoshi, Fujisawa (JP)

(21) Appl. No.: 17/365,863

(22) Filed: Jul. 1, 2021

(51) Int. Cl. G11B 5/73; G11B 5/66; G11B 5/65

(52) U.S. Cl. CPC G11B 5/7369; G11B 5/672; G11B 5/657; G11B 5/658; G11B 2005/0021

(57) ABSTRACT

Various apparatuses, systems, methods, and media are disclosed to provide a heat-assisted magnetic recording (HAMR) medium that has a magnesium (Mg) trapping layer that is configured to mitigate Mg migration in the HAMR medium so as to prevent near field transducer (NFT) damage caused by dissociated Mg reacting with a compound used in the NFT. In one example, the HAMR medium can include a substrate, a seed layer on the substrate and including MgO, a magnetic recording layer on the seed layer, and a Mg trapping layer on the substrate and configured to mitigate Mg migration from the seed layer to a surface of the HAMR medium above the magnetic recording layer.

### FIELD

The disclosure relates, in some aspects, to magnetic recording media for use with heat-assisted magnetic recording (HAMR), and more particularly, to HAMR media with a magnesium trapping layer to reduce magnesium migration to a nearby slider.

### INTRODUCTION

Magnetic storage systems, such as a hard disk drive (HDD), are utilized in a wide variety of devices in both stationary and mobile computing environments. Examples of devices that incorporate magnetic storage systems include desktop computers, portable notebook computers, portable hard disk drives, digital versatile disc (DVD) players, high definition television (HDTV) receivers, vehicle control systems, cellular or mobile telephones, television set top boxes, digital cameras, digital video cameras, video game consoles, and portable media players.

A typical disk drive includes magnetic storage media in the form of one or more fiat disks. The disks are generally formed of two main substances, namely, a substrate material that gives it structure and rigidity, and a magnetic media coating that holds the magnetic impulses or moments that represent data in a recording layer within the coating. The typical disk drive also includes a read head and a write head, generally in the form of a magnetic transducer which can sense and/or change the magnetic fields stored on the recording layer of the disks.

Energy/Heat Assisted Magnetic Recording (EAMR/HAMR) systems can increase the areal density of information recorded magnetically on various magnetic media. To achieve higher areal density for magnetic storage, smaller magnetic grain size (e.g., less than 6 nm) media may be required. In HAMR, high temperatures are applied to the media during writing to facilitate recording to small grains. However, the use of these high temperatures can present operational challenges and undesirable effects such as reliability issues in the HAMR components, including the media and head/slider.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

In one embodiment, a medium configured for heat-assisted magnetic recording (HAMR) includes a substrate, a seed layer on the substrate and comprising MgO, a magnetic recording layer on the seed layer, and a Mg trapping layer on the substrate. The Mg trapping layer is configured to mitigate Mg migration from the seed layer to a surface of the HAMR medium above the magnetic recording layer. The Mg trapping layer comprises an oxide selected from the group consisting of TiO, TiO₂, SiO, BaO, HfO, ZrO, MgTiO, MgTiO₂, MgSiO, MgBaO, MgHfO, MgZrO, and combinations thereof.

In one embodiment, a heat-assisted magnetic recording (HAMR) medium includes a substrate, a seed layer on the substrate and comprising MgO, a magnetic recording layer on the seed layer, and a Mg trapping layer on the substrate. The Mg trapping layer is configured to mitigate Mg migration from the seed layer to a surface of the HAMR medium above the magnetic recording layer. The Mg trapping layer comprises a first compound having a first bond dissociation energy that is lower than a second bond dissociation energy of SiO₂, and the first compound comprises less than 90 atomic percent of Mg.

In one embodiment, a method for manufacturing a heat-assisted magnetic recording (HAMR) medium is disclosed. The method includes: providing a substrate; providing a seed layer on the substrate, the seed layer comprising MgO; providing a magnetic recording layer on the seed layer; and providing a Mg trapping layer on the substrate, the Mg trapping layer configured to mitigate Mg migration from the seed layer to a surface of the HAMR medium above the magnetic recording layer. The Mg trapping layer comprises an oxide selected from the group consisting of TiO, TiO₂, SiO, BaO, HfO, ZrO, MgTiO, MgTiO₂, MgSiO, MgBaO, MgHfO, MgZrO, and combinations thereof.

In one embodiment, a method for manufacturing a heat-assisted magnetic recording (HAMR) medium is disclosed. The method includes: providing a substrate; providing a seed layer on the substrate, the seed layer comprising MgO; providing a magnetic recording layer on the seed layer; and providing a Mg trapping layer on the substrate, the Mg trapping layer configured to mitigate Mg migration from the seed layer to a surface of the HAMR medium above the magnetic recording layer. The Mg trapping layer comprises a first compound having a first bond dissociation energy that is lower than a second bond dissociation energy of SiO₂, and the first compound comprises less than 90 percent of Mg.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations, it should be understood that such implementations can be implemented in various devices, systems, and methods,

### BRIEF DESCRIPTION OF THE DRAWINGS

A more particular description is included below with reference to specific aspects illustrated in the appended drawings. Understanding that these drawings depict only certain aspects of the disclosure and are not therefore to be considered to be limiting of its scope, the disclosure is described and explained with additional specificity and detail through the use of the accompanying drawings, in which:

FIG. 1 is a top schematic view of a disk drive configured for heat-assisted magnetic recording (HAMR) including a slider and a HAMR medium with a magnesium (Mg) trapping layer in accordance with one aspect of the disclosure.

FIG. 2 is a side schematic view of the slider and HAMR medium of FIG. 1 with a Mg trapping layer in accordance with one aspect of the present.

FIG. 3 is a side schematic view of a first HAMR medium with a Mg trapping layer for reducing Mg migration in accordance with one aspect of the disclosure.

FIG. 4 is a side schematic view of a second HAMR medium with a Mg trapping layer for reducing Mg migration in accordance with one aspect of the disclosure.

FIG. 5 is a side schematic view of a third HAMR medium with a Mg trapping layer for reducing Mg migration in accordance with one aspect of the disclosure.

FIG. 6 is a flowchart of a process for fabricating a HAMR medium with a Mg trapping layer for mitigating Mg mitigation in accordance with some aspects of the disclosure.

FIG. 7 is a drawing illustrating a lattice structure of a Mg trapping layer located between a magnetic recording layer and a seed layer according to one aspect of the disclosure.

### DETAILED DESCRIPTION

In the following detailed description, reference is made to the accompanying drawings, which form a part thereof. In addition to the illustrative aspects, aspects, and features described above, further aspects, aspects, and features will become apparent by reference to the drawings and the following detailed description. The description of elements in each figure may refer to elements of proceeding figures. Like numbers may refer to like elements in the figures, including alternate aspects of like elements.

The disclosure relates in some aspects to various apparatuses, systems, methods, and media for providing heat-assisted magnetic recording (HAMR) media that can improve the reliability of a near field transducer (NFT) used in a slider of a HAMR disk drive. In a HAMR disk drive, a laser source and an optical waveguide with a NFT (typically implemented on or in a slider) are used to generate localized heating in the media while a writing element or writer writes data to the media.

In some aspects, magnesium (Mg), often in the form of MgO, may be used in a seed layer of a HAMR medium or disk. However, Mg atoms or ions can dissociate from the seed layer and migrate to the disk surface, and further to the slider/head positioned just above the disk surface. The migrated Mg on the disk surface and on the slider may cause damage (e.g., severe damage) to the NFT that is within the slider disposed just above the disk. The Mg on the disk surface or on the slider can react with Si or Si compound (e.g., SiO₂ (quartz)) that forms the cladding for the NFT and adversely affects the NFT. For example, the migrated Mg can react with NFT Si and form a SiMgO compound. The SiMgO compound has a lower thermal conductivity than Si or Si compound (e.g., quartz). Thermal stress can accumulate on the NFT because of the new compound has a lower thermal conductivity, and excess thermal stress (e.g., heat) can damage the NFT structure. Furthermore, SiMgO compounds (e.g., talc) can have a layered mineral structure. Thus, this layered SiMgO substance on the NFT can easily break off from the NFT during HDD operation and cause HAMR disk failure. Therefore, improving the reliability of the NFT can improve the lifespan of a HAMR disk drive.

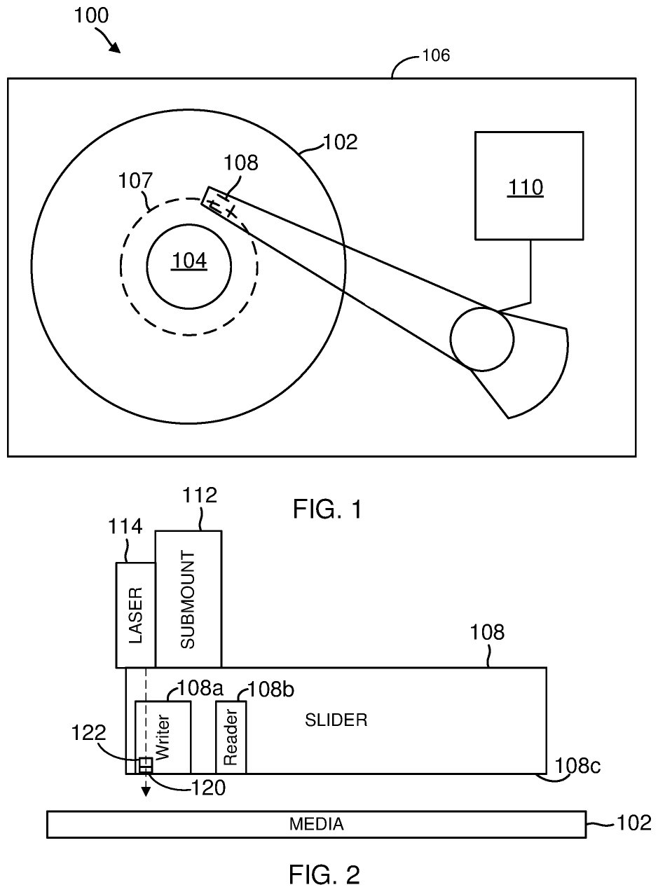

FIG. 1 is a top schematic view of a data storage device 100 (e.g., disk drive or magnetic recording device) configured for heat assisted magnetic recording (HAMR) comprising a slider 108 and a magnetic recording medium 102 with reduced Mg migration according to one or more aspects of the disclosure. The laser (not visible in FIG. 1 but see 114 in FIG. 2) is positioned with a head/slider 108. Disk drive 100 may comprise one or more disks/media 102 to store data. Disk/media 102 resides on a spindle assembly 104 that is mounted to a drive housing 106. Data may be stored along tracks in the magnetic recording layer of disk 102. The reading and writing of data is accomplished with the head 108 (slider) that may have both read and write elements (108a and 108b). The write element 108a is used to alter the properties of the magnetic recording layer of disk 102 and thereby write information thereto. In one aspect, head 108 may have magneto-resistive (MR) based elements, such as tunnel magneto resistive (TMR) elements for reading, and a write pole with coils that can be energized for writing. In operation, a spindle motor (not shown) rotates the spindle assembly 104, and thereby rotates the disk 102 to position the head 108 at a particular location along a desired disk track 107. The position of the head 108 relative to the disk 102 may be controlled by the control circuitry 110 (e.g., a microcontroller). It is noted that while an example HAMR system is shown, the various embodiments described may be used in other EAMR or non-EAMR magnetic data recording systems, including perpendicular magnetic recording (PMR) disk drives or magnetic tape drives.

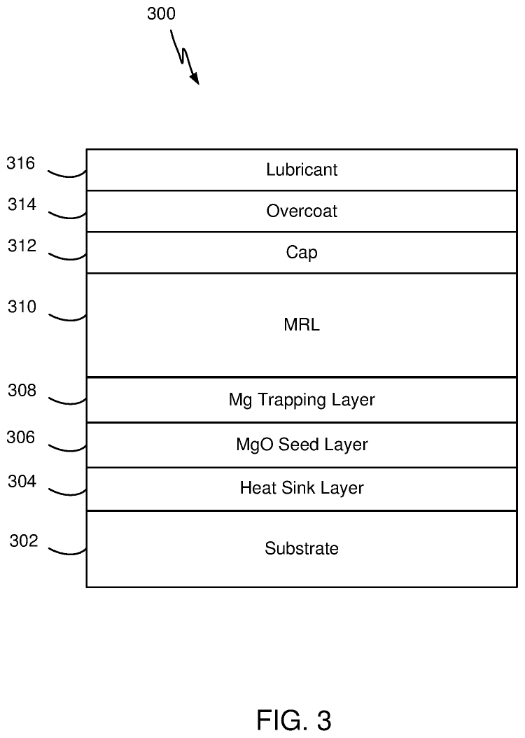

FIG. 2 is a side schematic view of the slider 108 and magnetic recording medium 102 of FIG. 1. The magnetic recording medium 102 may have one or more Mg trapping layers (FIGS. 3-5) to reduce Mg migration in accordance with one or more aspects of the disclosure. The slider 108 may comprise a sub-mount 112 attached to a top surface of the slider 108. The laser 114 may be attached to the sub-mount 112, and possibly to the slider 108. The slider 108 comprises a write element (e.g., writer) 108a and a read element (e.g., reader) 108b positioned along an air bearing surface (ABS) 108c of the slider for writing information to, and reading information from, respectively, the media 102. In other aspects, the slider may also comprise a layer of Si or Si cladding 120.

In operation, the laser 114 is configured to generate and direct light energy to a. waveguide (e.g., along the dashed line) in the slider which directs the light to a near field transducer (NFT) 122 near the air bearing surface (e.g., bottom surface) 108c of the slider 108. Upon receiving the light from the laser 114 via the waveguide, the NFT 122 generates localized heat energy that heats a portion of the media 102 within or near the write element 108a, and near the read element 108b. The anticipated recording temperature is in the range of about 350° C. to 400° C. In the aspect illustrated in FIG. 2, the laser directed light is disposed within the writer 108a and near a trailing edge of the slider. In other aspects, the laser directed light may instead be positioned between the writer 108a and the reader 108b. FIGS. 1 and 2 illustrate a specific example of a HAMR system. In other examples, the magnetic recording medium 102 with reduce Mg migration according to aspects of the disclosure can be used in other suitable HAMR systems (e.g., with other sliders configured for HAMR).

In some aspects, a HAMR medium can include an underlayer (e.g., a MgO seed layer) for growing one or more magnetic recording layers (e.g., FePt magnetic recording layers). However, as described above, Mg may migrate (dissociate) from the seed layer and escape from a surface of the HAMR medium during disk drive operations. The escaped Mg can have an adverse and unexpected effect in a HAMR HDD. For example, the dissociated Mg can adversely affect a head disk interface (e.g., NFT in a slider) when the Mg reacts with a Si compound (e.g., SiO₂) on the NFT. The Mg escaped from the HAMR medium can break the Si—O bond in SiO₂ at the NFT, and forms MgO or SiMgO that can peel off from the NFT.

Some aspects of the disclosure provide a HAMR medium configured to mitigate Mg migration so as to reduce the quantity of dissociated Mg available to react with the SiO₂ of an NFT. To that end, the HAMR medium may include a Mg trapping layer to reduce Mg migration from a seed layer. In some aspects, the Mg trapping layer includes a substance or material (e.g., an oxide compound) that can react with the dissociated Mg. The Mg trapping substance or material may be selected to have a bond dissociation energy lower than that of the Si—O bond in SiO₂ of the NFT; therefore, the dissociated Mg reacts with the Mg trapping substance before it can escape from the HAMR medium to react with the SiO₂ of the NFT. The bond dissociation energy of the Si—O bond in SiO₂ is about 798 kJ/mol. Therefore, the selected Mg trapping substance or material has a bond dissociation energy lower than 798 kJ/mol. In other words, the Mg trapping layer can work as an Mg absorbent. During laser irradiation of a portion of a HAMR medium (e.g., for writing), Mg can diffuse from a MgO seed layer. The diffused Mg ions or atoms can go above and below the MgO seed layer. Some Mg can migrate to the disk surface. The Mg trapping layer can trap or absorb dissociated Mg before it can reach and escape from the disk surface. Some examples of suitable Mg trapping compound or material are TiO, TiO₂, SiO, BaO, HfO, ZrO, MgTiO, MgTiO₂, MgSiO, MgBaO, MgHfO, and MgZrO. The bond dissociation energy of some exemplary oxides are shown in Table 1 below.

TABLE 1

| Bond | kJ/mol |
|---|---|
| SiO₂ | 798 |
| SiO | 531 |
| TiO (TiO₂) | 662 |
| BaO | 563 |
| HfO | 791 |
| ZrO | 760 |
| MgO | 394 |

FIG. 3 is a side schematic view of a first HAMR medium 300 with a Mg trapping layer for reducing Mg migration in accordance with one aspect of the disclosure. The HAMR medium 300 has a stacked structure with a substrate 302 at a bottom/base layer, a heat sink layer 304 on the substrate 302, a MgO seed layer 306 on the heat sink layer 304, a Mg trapping layer 308 on the seed layer 306, a magnetic recording layer (MRL) 310 on the Mg trapping layer 308, a capping layer 312 on the MRL 310, an overcoat layer 314 on the capping layer 312, and a lubricant layer 316 on the overcoat layer 314. In some examples, the MRL 310 may include one or more magnetic recording layers.

In some aspects, the substrate 302 may be made of one or more materials such as an Al alloy, NiP plated Al, glass, glass ceramic, and/or combinations thereof. In some aspects, the heat sink layer 304 can be made of one or more materials such as Ag, Al, Au, Cu, Cr, Mo, Ru, W, CuZr, MoCu, AgPd, CrRu, CrV, CrW, CrMo, CrNd, NiAl, NiTa, combinations thereof, and/or other suitable materials known in the art. In some aspects, the MgO seed layer 306 may be made of MgO or other suitable materials known in the art. In one embodiment, the MgO seed layer 306 has a certain lattice structure that determines or limits a lattice structure of a layer (e.g., Mg trapping layer 308) grown/deposited on the MgO seed layer 306.

In some aspects, the Mg trapping layer 308 may be made of a Mg trapping compound, for example, TiO, SiO, BaO, HfO, ZrO, MgTiO, MgTiO₂, MgSiO, MgBaO, MgHfO, MgZrO, or combinations thereof. The Mg trapping compound can react with the Mg ions or atoms dissociated from the MgO seed layer 306. The Mg trapping compound may be selected to have a bond dissociation energy lower than that of the Si—O bond in SiO₂ of the NFT; therefore, the dissociated Mg may react with the Mg trapping compound before it can escape from the HAMR medium to react with the SiO₂ of the NFT. In one embodiment, the Mg trapping compound has a bond dissociation energy lower than about 798 kJ/mol. In some aspects, the Mg trapping layer 308 may have a thickness that can facilitate coherent growth with a lattice structure substantially matching the MgO seed layer 306. Therefore, when the MRL 310 is grown on the Mg trapping layer 308, the lattice mismatch between the MRL 310 and the MgO seed layer can be reduced or minimized. For example, the MgO seed layer 306 may have a lattice constant of 4.2 Angstrom.

In one embodiment, the Mg trapping layer 308 may include a Mg compound (e.g., MgTiO, MgTiO₂, MgSiO, MgBaO, MgHfO, MgZrO) that contains less than 90 atomic percent Mg (e.g., less than about 90 atomic percent). For example, the Mg compound may include Mg(x)A₍₁₀₀₋ₓ₎O and/or Mg(x)A₍₁₀₀₋ₓ₎O₂, where A can be Ti, Si, Ba, Hf, and/or Zr, and X is atomic percent in the range of 0%≤90%. In one aspect, MgNiO, depending on a concentration of Mg contained therein, may be a suitable Mg trapping compound. In one specific example, MgNiO, with Mg concentration at 90 atomic percent or higher, may not be a suitable Mg trapping compound for use in the Mg trapping layer 308 even if MgNiO may have a bond dissociation energy lower than about 798 kJ/mol. While not bound by any particular theory, it is believed that the high concentration of Mg contained in this MgNiO (e.g., higher than 90 percent) causes the MgNiO layer to be ineffective (or largely ineffective) in trapping Mg, at least as compared to the other materials disclosed above as being suitable Mg trapping layer compounds. Possibly the high concentration of Mg in the MgNiO prevents or inhibits the disassociated Mg ions/atoms from bonding with the NiO within the MgNiO compound.

In some aspects, the MRL 310 may be made of FePt or an alloy selected from FePtX, where X is a material selected from Cu, Ni, and combinations thereof. In some aspects, the MRL 310 may be made of a CoPt alloy. In some aspects, the capping layer 312 may be made of Co, Pt, or Pd. In one example, the capping layer 312 can be a bi-layer structure having a top layer including Co and a bottom layer including Pt or Pd. In addition to the Co/Pt and Co/Pd combinations of the top layer and the bottom layer, specific combinations of the top layer materials and the bottom layer materials may include, for example, Co/Au, Co/Ag, Co/Al, Co/Cu, Co/Ir, Co/Mo, Co/Ni, Co/Os, Co/Ru, Co/Ti, Co/V, Fe/Ag, Fe/Au, Fe/Cu, Fe/Mo, Fe/Pd, Ni/Au, Ni/Cu, Ni/Mo, Ni/Pd, Ni/Re, etc. In additional examples, top layer materials and bottom layer materials include any combination of Pt and Pd (e.g., alloys), or any of the following elements, alone or in combination: Au, Ag, Al, Cu, Ir, Mo, Ni, Os, Ru, Ti, V, Fe, Re, and the like. In some aspects, the overcoat layer 314 may be made of carbon. In one aspect, the lubricant layer 316 is made of a polymer-based lubricant.

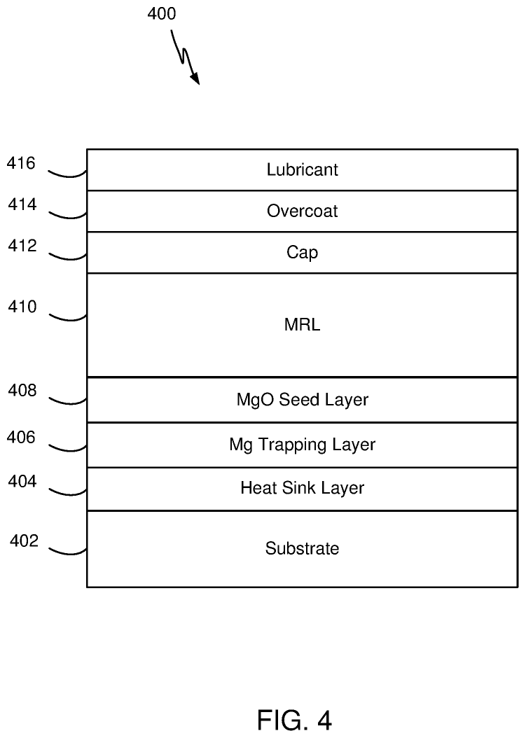

FIG. 4 is a side schematic view of a second HAMR medium 400 with a Mg trapping layer for reducing Mg migration in accordance with one aspect of the disclosure. The HAMR medium 400 has a stacked structure similar to the first HAMR medium 300. For example, the HAMR medium 400 has a substrate 402 at a bottom/base layer, a heat sink layer 404 on the substrate 402, a Mg trapping layer 406 on the heat sink layer 404, a MgO seed layer 408 on the Mg trapping layer 406, a MRL 410 on the MgO seed layer 408, a capping layer 412 on the MRL 410, an overcoat layer 414 on the capping layer 412, and a lubricant layer 416 on the overcoat layer 414. In some examples, the MRL 410 may include one or more magnetic recording layers. The materials used for the various layers of the HAMR medium 400 may be the same as or similar to those described above in relation to the HAMR medium 300. In HAMR, laser or light irradiation of the HAMR medium 400 can cause Mg atoms or ions from the MgO seed layer 408 to diffuse randomly around (i.e., above and below) the MgO seed layer. When some of the diffusing or migrating Mg ions or atoms go below the MgO seed layer, materials in the Mg trapping layer can react with and thereby absorb the migrating Mg atoms or ions. In addition, placing the Mg trapping layer 406 below the MgO seed layer 408 may facilitate the ease of growing of the MRL 410 directly on the MgO seed layer 408, for example, with a lattice structure matching the MgO seed layer 408. To the contrary, and for reasons related to potential lattice mismatch, it may be more difficult to grow the MRL 310 directly on the Mg trapping layer 308 in the example shown in FIG. 3.

In some aspects, the MgO seed layer and the Mg trapping layer of the HAMR medium 300/400 can be combined or manufactured as a single layer.

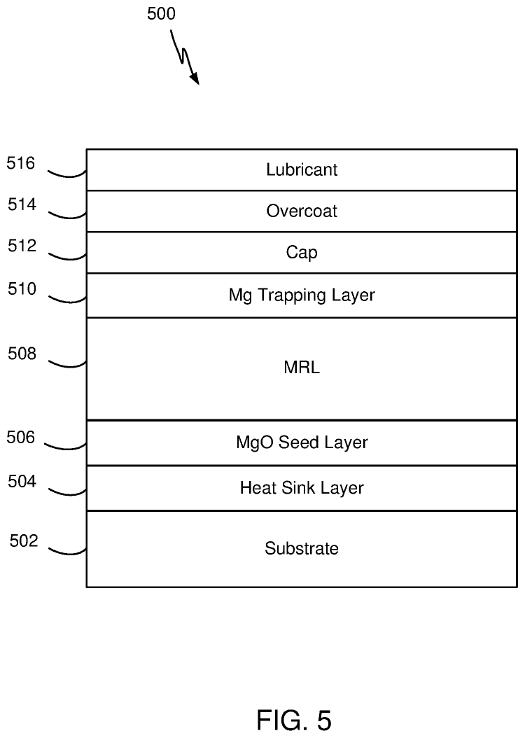

FIG. 5 is a side schematic view of a third HAMR medium 500 with a Mg trapping layer for reducing Mg migration in accordance with one aspect of the disclosure. The HAMR medium 500 has a stacked structure with a substrate 502 (e.g., a glass substrate) at a bottom/base layer, a heat sink layer 504 on the substrate 502, a MgO seed layer 506 on the heat sink layer 504, a MRL 508 on the MgO seed layer 506, a Mg trapping layer 510 on the MRL 508, a capping layer 512 on the Mg trapping layer 510, an overcoat layer 514 on the capping layer 512, and a lubricant layer 516 on the overcoat layer 414. In some examples, the MRL 510 may include one or more magnetic recording layers. The materials used for the various layers of the third HAMR medium 500 may be the same as or similar to those described above in relation to the first and/or second HAMR medium 300/400.

In this example, placing the Mg trapping layer 510 on the MRL 508 allows the MRL 508 to be formed directly on the MgO seed layer 506 such that it is easier to match the lattice structure of the MRL 508 with that of the MgO seed layer 506. This is in contrast to the HAMR medium 300 of FIG. 3, where the Mg trapping layer 308 is disposed between the MgO seed layer 306 and the MRL 310. In the HAMR medium 400 shown in FIG. 4, the MRL 410 can be formed directly on the MgO seed layer 408 and the Mg trapping layer 406 is formed below the MgO seed layer 408. However, while this configuration provides some Mg trapping, the Mg trapping layer may be more effective when placed above the MgO seed layer (as shown in FIGS. 3 and 5) to capture or absorb Mg ions or atoms migrating toward the surface of the HAMR medium.

The terms “above,” “below,' on,” and “between” as used herein refer to a relative position of one layer with respect to other layers. As such, one layer deposited or disposed on, above, or below another layer may be directly in contact with the other layer or may have one or more intervening layers. Moreover, one layer deposited or disposed between layers may be directly in contact with the layers or may have one or more intervening layers.

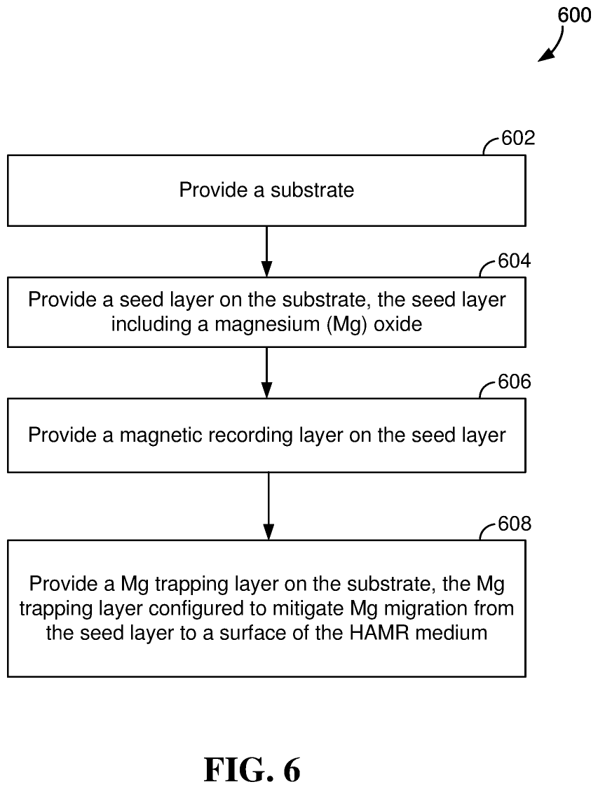

FIG. 6 is a flowchart of a process 600 for fabricating a HAMR medium with a Mg trapping layer for mitigating Mg migration in accordance with some aspects of the disclosure. In one aspect, the process 600 can be used or modified to fabricate any of the HAMR media described above in relation to FIGS. 3-5. In block 602, the process provides a substrate. In some aspects, the substrate can be made of one or more materials such as an Al alloy, NiP plated Al, glass, glass ceramic, and/or combinations thereof. In block 604, the process provides a seed layer on the substrate. In one example, the seed layer may include a MgO seed layer. In some aspects, the seed layer may be on a heat sink layer that is on the substrate. In block 606, the process provides a magnetic recording layer on the seed layer. In one example, the magnetic recording layer may include one or more magnetic recording layers for storing data magnetically. In block 608, the process provides a Mg trapping layer on the substrate. The Mg trapping layer is configured to mitigate Mg migration from the seed layer to a surface of the HAMR medium above the magnetic recording layer. In one example, the Mg trapping layer is between the MRL and the seed layer. In one example, the Mg trapping layer is the seed layer and the substrate or a heat sink layer on the substrate. In one example, the Mg trapping layer is between the MRL layer and a capping layer.

In one aspect, the Mg trapping layer can include an oxide selected from the group consisting of TiO, TiO₂, SiO, BaO, HfO, ZrO, MgTiO, MgTiO₂, MgSiO, MgBaO, MgHfO, MgZrO, or combinations thereof. In one aspect, the Mg trapping layer can include a first compound having a first bond dissociation energy that is lower than a second bond dissociation energy of a compound included in a NFT of a slider (e.g., SiO₂) for writing data to the HAMR medium. For example, the first compound may have a bond dissociation energy that is lower than 798 kJ/mol. In one aspect, the first compound can include Mg at less than 90 atomic percent.

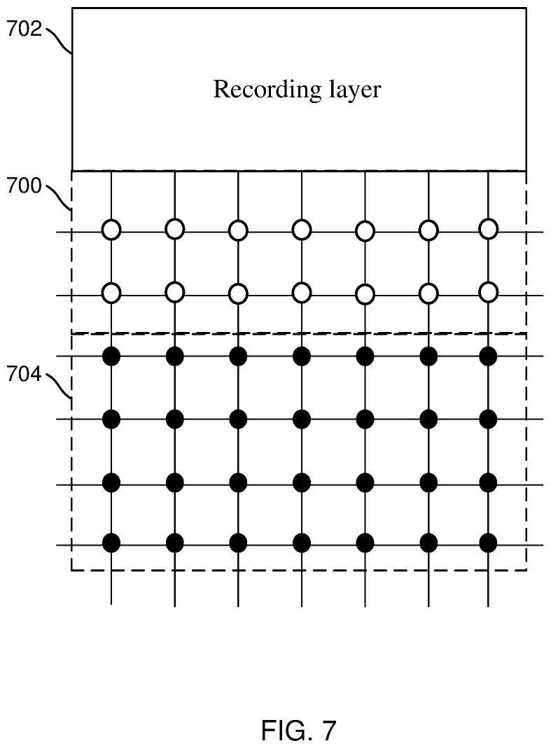

FIG. 7 is a drawing illustrating a lattice structure of an exemplary Mg trapping layer 700 located between a magnetic recording layer 702 and a seed layer 704 according to one aspect of the disclosure. In this example (which is similar in some aspects to the example of FIG. 3 where the Mg trapping layer is on the seed layer), the Mg trapping layer 700 can have a lattice structure matching the lattice structure of the seed layer 704 (e.g., MgO seed layer). Matching the lattice structure of the Mg trapping layer 700 and the seed layer 704 can facilitate the, growing of the recording layer 702 on the Mg trapping layer 700 during manufacturing of the HAMR medium. Furthermore, the lattice structure of the recording layer 702 and/or the lattice structure of the Mg trapping layer 700 can be controlled to minimize a lattice mismatch between these layers. Reducing the lattice mismatch between the recording layer 702 and either of the Mg trapping layer 700 or the seed layer 704 can facilitate the overall media performance and possibly the manufacturing of these different layers in a HAMR medium. In one aspect, the lattice structures of the Mg trapping layer 700 and the seed layer 704 are matched by selecting suitable materials and/or thickness for the Mg trapping layer 700. For example, the lattice misfit between the Mg trapping layer 700 and the seed layer 704 is less than about 10%.

In one aspect, the process can perform the sequence of actions in a different order. In another aspect, the process can skip one or more of the actions. In other aspects, one or more of the actions are performed simultaneously. In some aspects, additional actions can be performed.

In several aspects, the deposition of such layers can be performed using a variety of deposition sub-processes, including, but not limited to physical vapor deposition (PVD), sputter deposition and ion beam deposition, and chemical vapor deposition (CVD) including plasma enhanced chemical vapor deposition (PECVD), low pressure chemical vapor deposition (LPCVD) and atomic layer chemical vapor deposition (ALCVD). In other aspects, other suitable deposition techniques known in the art may also be used.

### Additional Aspects

The examples set forth herein are provided to illustrate certain concepts of the disclosure. The apparatuses, devices, or components illustrated above may be configured to perform one or more of the methods, features, or steps described herein. Those of ordinary skill in the art will comprehend that these are merely illustrative in nature, and other examples may fall within the scope of the disclosure and the appended claims. Based on the teachings herein those skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

Aspects of the present disclosure have been described above with reference to schematic flowchart diagrams and/or schematic block diagrams of methods, apparatuses, systems, and computer program products according to aspects of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

The subject matter described herein may be implemented in hardware, software, firmware, or any combination thereof. As such, the terms “function,” “module,” and the like as used herein may refer to hardware, which may also include software and/or firmware components, for implementing the feature being described. In one example implementation, the subject matter described herein may be implemented using a computer readable medium having stored thereon computer executable instructions that when executed by a computer (e.g., a processor) control the computer to perform the functionality described herein. Examples of computer-readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

It should also be noted that, in some alternative implementations, the functions noted in the block may occur out of the order noted in the figures, For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding aspects. For instance, an arrow may indicate a waiting or monitoring period of unspecified duration between enumerated steps of the depicted aspect.

The various features and processes described above may be used independently of one another, or may be combined in various ways. All possible combinations and sub-combinations are intended to fall within the scope of this disclosure. In addition, certain method, event, state or process blocks may be omitted in some implementations. The methods and processes described herein are also not limited to any particular sequence, and the blocks or states relating thereto can be performed in other sequences that are appropriate. For example, described tasks or events may be performed in an order other than that specifically disclosed, or multiple may be combined in a single block or state. The example tasks or events may be performed in serial, in parallel, or in some other suitable manner. Tasks or events may be added to or removed from the disclosed example aspects. The example systems and components described herein may be configured differently than described. For example, elements may be added to, removed from, or rearranged compared to the disclosed example aspects.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The word “exemplary” is used herein to mean “serving as an example, instance, or illustration.” Any aspect described herein as“exemplary” is not necessarily to be construed as preferred or advantageous over other aspects. Likewise, the term “aspects” does not require that all aspects include the discussed feature, advantage or mode of operation.

While the above descriptions contain many specific aspects of the invention, these should not be construed as limitations on the scope of the invention, but rather as examples of specific aspects thereof. Accordingly, the scope of the invention should be determined not by the aspects illustrated, but by the appended claims and their equivalents. Moreover, reference throughout this specification to “one aspect,” “an aspect,” or similar language means that a particular feature, structure, or characteristic described in connection with the aspect is included in at least one aspect of the present disclosure. Thus, appearances of the phrases “in one aspect,” “in an aspect,” and similar language throughout this specification may, but do not necessarily, all refer to the same aspect, but mean “one or more but not all aspects” unless expressly specified otherwise.

The terminology used herein is for the purpose of describing particular embodiments only and is not intended to be limiting of the embodiments. As used herein, the singular forms “a,” “an” and “the” are intended to include the plural forms as well (i.e., one or more), unless the context clearly indicates otherwise. An enumerated listing of items does not imply that any or all of the items are mutually exclusive anti/or mutually inclusive, unless expressly specified otherwise. It will be further understood that the terms “comprises,” “comprising,” “includes” “including,” “having,” an variations thereof when used herein mean “including but not limited to” unless expressly specified otherwise. That is, these terms may specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “/” between two adjacent words has the same meaning as “or” unless expressly stated otherwise. Moreover, phrases such as “connected to,” “coupled to” or “in communication with” are not limited to direct connections unless expressly stated otherwise.

Any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be used there or that the first element must precede the second element in some manner. Also, unless stated otherwise a set of elements may include one or more elements. In addition, terminology of the form “at least one of a, b, or c” or “a, b, c, or any combination thereof” used in the description or the claims means “a or b or c or any combination of these elements.” For example, this terminology may include a, or b, or c, or a and b, or a and c, or a and b and c, or 2a, or 2b, or 2c, or 2a and b, and so on.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

1. A medium configured for heat-assisted magnetic recording (HAMR), the medium comprising:
a substrate;
a seed layer on the substrate and comprising MgO;
a magnetic recording layer on the seed layer; and
a Mg trapping layer on the substrate and configured to mitigate Mg migration from the seed layer to a surface of the medium above the magnetic recording layer,
wherein the Mg trapping layer is in direct contact with the magnetic recording layer and the seed layer, and
wherein the Mg trapping layer consists of an oxide selected from the group consisting of TiO, TiO₂, SiO, BaO, HfO, ZrO, MgTiO, MgTiO₂, MgSiO, MgBaO, MgHfO, MgZrO, and combinations thereof.

2. The medium of claim 1, wherein the Mg trapping layer is disposed between the magnetic recording layer and the seed layer.

3. The medium of claim 1, wherein a lattice mismatch between the Mg trapping layer and the seed layer is less than about 10 percent.

4. The HAMR medium of claim 1, wherein the Mg trapping layer is disposed between the seed layer and the substrate.

5. The HAMR medium of claim 1, wherein the Mg trapping layer is disposed between the magnetic recording layer and the surface of the HAMR medium.

6. The HAMR medium of claim 5, further comprising a capping layer above the magnetic recording layer, wherein the Mg trapping layer is disposed between the magnetic recording layer and the capping layer.

7. The HAMR medium of claim 1, wherein an atomic scale thickness of the Mg trapping layer is between 1 and 3, inclusive.

8. The medium of claim 1, wherein a thickness of the Mg trapping layer is between 5 Angstrom (Å) and 20 Å, inclusive.

9. A data storage comprising the medium of claim 1.

10. A heat-assisted magnetic recording (HAMR) medium, the HMR medium comprising:
a substrate;
a seed layer on the substrate and comprising MgO;
a magnetic recording layer on the seed layer; and
a Mg trapping layer on the substrate and configured to mitigate Mg migration from the seed layer to a surface of the HAMR medium above the magnetic recording layer,
wherein the Mg trapping layer comprises a first compound having a first bond dissociation energy that is lower than a second bond dissociation energy of SiO2, and
the first compound comprises less than 90 atomic percent of Mg.

11. The magnetic recording medium of claim 10, wherein the first bond dissociation energy corresponds to a bond dissociation energy of an oxide included in the Mg trapping layer.

12. The magnetic recording medium of claim 11, wherein a bond dissociation energy of the oxide is lower than 798 kJ/mol.

13. The magnetic recording medium of claim 11, wherein the first compound is selected from the group consisting of MgTiO, MgTiO2, MgSiO, MgBaO, MgHfO, MgZrO, and combinations thereof.

14. The magnetic recording medium of claim 10, wherein the Mg trapping layer is disposed between the magnetic recording layer and the seed layer.

15. The magnetic recording medium of claim 10, wherein the Mg trapping layer is disposed between the seed layer and the substrate.

16. The magnetic recording medium of claim 10, wherein the Mg trapping layer is disposed between the magnetic recording layer and the surface of the HAMR medium.

17. The magnetic recording medium of claim 16, further comprising a capping layer above the magnetic recording layer, wherein the Mg trapping layer is disposed between the magnetic recording layer and the capping layer.

18. A data storage device comprising:
the HAMR medium of claim 10; and
a write head configured to write data to the HAMR medium and comprising a near field transducer (NFT),
wherein the first bond dissociation energy is lower than the second bond dissociation energy of SiO2 included in the near field transducer (NFT).

19. A method for manufacturing a heat-assisted magnetic recording (HAMR) medium, the method comprising:
providing a substrate;
providing a seed layer on the substrate, the seed layer comprising MgO;
providing a magnetic recording layer on the seed layer; and
providing a Mg trapping layer on the substrate, the Mg trapping layer configured to mitigate Mg migration from the seed layer to a surface of the HAMR medium above the magnetic recording layer,
wherein the Mg trapping layer is in direct contact with the magnetic recording layer and the seed layer, and
wherein the Mg trapping layer comprises an oxide selected from the group consisting of TiO, TiO₂, SiO, BaO, HfO, ZrO, MgTiO, MgTiO₂, MgSiO, MgBaO, MgHfO, MgZrO, and combinations thereof.

20. The method of claim 19, wherein the providing the Mg trapping layer comprises:
providing the Mg trapping layer between the magnetic recording layer and the seed layer.

21. The method of claim 19, wherein the providing the Mg trapping layer comprises:
providing the Mg trapping layer between the seed layer and the substrate.

22. The method of claim 19, wherein the providing the Mg trapping layer comprises:
providing the Mg trapping layer between the magnetic recording layer and the surface of the HAMR medium.

23. The method of claim 22, further comprising providing a capping layer above the magnetic recording layer, wherein the Mg trapping layer is disposed between the magnetic recording layer and the capping layer.

24. A method for manufacturing a heat-assisted magnetic recording (HAMR) medium, the method comprising:
providing a substrate;
providing a seed layer on the substrate, the seed layer comprising MgO;
providing a magnetic recording layer on the seed layer; and
providing a Mg trapping layer on the substrate, the Mg trapping layer configured to mitigate Mg migration from the seed layer to a surface of the HAMR medium above the magnetic recording layer,
wherin the Mg trapping layer comprises a first compound having a first bond dissociation energy that is lower than a second bond dissociation energy of SiO2, and
the first compound comprises less than 90 percent of Mg.

25. The method of claim 24, wherein the providing the Mg trapping layer comprises:
providing the Mg trapping layer between the magnetic recording layer and the seed layer.

26. The method of claim 24, wherein the providing the Mg trapping layer comprises:
providing the Mg trapping layer between the seed layer and the substrate.

27. The method of claim 24, wherein the providing the Mg trapping layer comprises:
providing the Mg trapping layer between the magnetic recording layer and the surface of the HAMR medium.

28. The method of claim 27, further comprising providing a capping layer above the magnetic recording layer, wherein the Mg trapping layer is disposed between the magnetic recording layer and the capping layer.
